(19) United States
(12) Patent Application Publication
(10) Pub. No.: US 2025/0333270 A1
(43) Pub. Date: Oct. 30, 2025

(54) Belt for Carrying an Elevator Car and/or a Counterweight of an Elevator System

(71) Applicant: Inventio AG, Hergiswil (CH)

(72) Inventors: Volker Zapf, Kriens-Obernau (CH); Florian Dold, Cham (CH); Oliver Berner, Sursee (CH); Dominique Hess, Bonstetten (CH)

(21) Appl. No.: 18/864,570

(22) PCT Filed: May 16, 2023
(86) PCT No.: PCT/EP2023/063120

§ 371 Date: Nov. 11, 2024

(30) Foreign Application Priority Data
May 17, 2022 (EP) 22173655.6

(51) Int. Cl. B66B 7/06; B29C 48/08; B29C 48/154; B29L 29/00; B66B 7/12; B66B 9/00; D07B 1/02; D07B 1/06; D07B 1/16

(52) U.S. Cl. CPC B66B 7/062; B29C 48/08; B29C 48/154; B66B 7/1223; D07B 1/02; D07B 1/0606; D07B 1/16; B29K 2995/0077; B29L 2029/00; B66B 9/00; D07B 2201/1004; D07B 2201/202; D07B 2201/2024; D07B 2201/2041; D07B 2205/3025; D07B 2501/2007

(57) ABSTRACT

A belt for carrying an elevator car and/or a counterweight of an elevator system includes a belt body with a traction side for contacting a traction sheave of the elevator system and a back side opposite the traction side. The belt body has a groove profile on the traction side adapted to an outer contour of the traction sheave, and has a profile on the back side deviating from the groove profile. Multiple tension members are embedded in the belt body for transmitting tensile forces, wherein each tension member is formed by multiple strands twisted together, and each strand is formed by multiple aramid fibers twisted together.

### FIELD

The present invention relates to a belt for carrying an elevator car and/or a counterweight of an elevator system. Furthermore, the invention relates to a method for producing such a belt and to an elevator system having such a belt.

### BACKGROUND

For example, an elevator car in an elevator system can be suspended from multiple steel cables that are guided over a traction sheave driven by an electric drive and are frictionally connected to it. Turning the traction sheave can then raise or lower the elevator car. Instead of such steel cables, special belts can be used. Such a belt usually comprises a band-shaped belt body made of an elastomer material, in which multiple tension members in the form of comparatively thin steel cables are embedded. The tension members serve to absorb the majority of the dynamic and/or static tensile forces occurring during operation of the elevator system. The frictional connection with the traction sheave is established via the belt body. In the interests of easy assembly and/or disassembly and efficient operation of the elevator system, the belt should be as light as possible and have a high breaking load in relation to its own weight.

Examples of such belts are described in EP 2 356 055 B1 and WO 2016/030298 A1.

An artificial fiber cable for an elevator system is described in EP 1 905 892 A2.

### SUMMARY

There may therefore be a need for an improved, particularly weight-optimized belt for carrying an elevator car and/or a counterweight of an elevator system. In addition, there may be a need for a corresponding method for producing such a belt, and a corresponding elevator system.

These needs can be met by the subject matter of the advantageous embodiments defined in the following description and in the accompanying drawings.

A first aspect of the invention relates to a belt for carrying an elevator car and/or a counterweight of an elevator system. The belt comprises a belt body with a traction side for contacting a traction sheave of the elevator system and a back side opposite the traction side, wherein the belt body has a groove profile on the traction side adapted to an outer contour of the traction sheave and a profile on the back side that differs from the groove profile (for example, the belt body can be flat on the back side or have a different groove profile than on the traction side). In addition, the belt comprises multiple tension members embedded in the belt body for the purpose of transmitting tensile forces, wherein each tension member is formed from multiple strands twisted together, and each strand is formed from multiple metallic or non-metallic fibers twisted together, in particular aramid fibers or steel fibers.

Such a belt is significantly lighter than similar belts with steel tension members while having the same load-bearing capacity. This simplifies the handling of the belt, especially during assembly and/or disassembly in very tall buildings such as skyscrapers (in these cases the belt can be multiple hundred or even more than a thousand meters long, depending on the height of the building). In tests, such a belt also proved to be particularly durable and low-maintenance. The lower weight with the same breaking load means that less mass has to be moved. Furthermore, such a light belt enables a higher cabin car load than would be possible with a conventional heavy belt.

A belt body can generally be understood as a sheathing of the tension members. The belt body can be made of an elastomer material, in particular of polyurethane or an elastomer material comprising polyurethane.

In particular, a belt can be wider than it is high.

The expression “embedded in the belt body” can be understood above and below as “partially or completely surrounded by the belt body.”

The tension members (also called cords or tension strands) can be arranged next to and/or above each other in the belt body. In particular, the tension members can be evenly distributed across the width of the belt body. It is also advantageous if all tension members are at the same height and/or have the same running radius.

For example, each strand can be formed by multiple yarns twisted together, wherein each yarn can be formed by multiple unidirectional, i.e., non-twisted, aramid fibers. For example, each yarn may contain more than 100 or more than 1000 aramid fibers. Each yarn may additionally have been impregnated in a plastic bath.

Other non-metallic fibers, such as glass fibers, can also be used. It is particularly advantageous to use high-strength fibers with a tensile strength greater than 1000 N/mm2, in particular 2000 N/mm2, preferably 3000 N/mm2, particularly preferably 4000 N/mm2, in particular 5000 N/mm2.

The strand formed from the yarns may optionally have been subjected to a heat treatment to smooth the outer surface of the strand.

The strands of the same tension member can be the same and/or different thicknesses.

For example, the strands of each tension member can be twisted together in a first lay direction and the aramid fibers (or yarns) of each strand of the tension member can be twisted together in a second lay direction deviating from the first lay direction.

The lay length of a single strand can, for example, be between 20 mm and 30 mm, in particular between 21 mm and 25 mm (for the thickest strand).

The lay length of a single tension member can, for example, be between 40 mm and 60 mm, in particular between 48 mm and 52 mm (plus/minus 2 mm).

It is possible that each tension member comprises exclusively aramid fibers, i.e., it does not comprise any other fibers or wires (e.g., steel wires) in addition to the aramid fibers. However, tension members with a mixed composition, which include other fibers or wires (e.g., steel wires or carbon fibers) in addition to the aramid fibers, are also conceivable.

In tests, variants of the belt have proven to be particularly advantageous in which the ratio of breaking load (in kN) to width (in mm) of the belt is greater than 2, in particular greater than 3, particularly preferably between 3.6 and 3.75 and/or greater than 4, in particular greater than 5, particularly preferably between 5.2 and 5.4 kN/mm.

A second aspect of the invention relates to a method for producing a belt for carrying an elevator car and/or a counterweight of an elevator system, in particular the belt described above and below. The method comprises the following steps: providing multiple tension members for the purpose of transmitting tensile forces, each tension member being formed from multiple strands twisted together, and each strand being formed from multiple aramid fibers twisted together; preheating the tension members to a temperature between 120° C. and 160° C., preferably between 130° C. and 150° C., particularly preferably between 135° C. and 145° C.; molding a belt body embedding the tension members, with a traction side for contacting a traction sheave of the elevator system and a back side opposite the traction side, by embedding the preheated tension members in an elastomer material, by extruding the elastomer material.

This method makes it possible for the belt to be manufactured in a particularly efficient manner.

For preheating, the tension members can be heated locally in one or more sections. The heated section or sections may, for example, be sections that are subsequently to be embedded in the elastomer material.

In particular, the belt body can be formed on the traction side with a groove profile adapted to an outer contour of the traction sheave and on the back side with a profile deviating from the groove profile (for example, the belt body can be formed flat on the back side or with a different groove profile than on the traction side). In this case, for example, a profile height of the groove profile can correspond to at least half the total height of the belt.

It is noted that features of the method may also be features of the belt described above and below (and vice versa).

A third aspect of the invention relates to an elevator system. The elevator system comprises the belt described above and below and an elevator shaft. In addition, the elevator system comprises an elevator car arranged to be able to travel in the elevator shaft, wherein the belt carries the elevator car, or a counterweight arranged to be able to travel in the elevator shaft, wherein the belt carries the counterweight, or both the elevator car and the counterweight.

The elevator car and the counterweight can be connected to each other via the same belt or each can be carried by its own belt.

Without restricting the scope of the invention in any way, embodiments of the invention may be considered to be based on the concepts and findings described below.

According to one embodiment, a profile height of the groove profile can correspond to at least half the total height of the belt. Additionally or alternatively, the belt body may be flat on the back side, as mentioned above. This allows the belt to be made particularly flat. This improves, among other things, the flexibility of the belt. The sheath also protects the tension members from environmental influences such as moisture and UV rays.

According to one embodiment, each tension member can comprise a central strand and multiple, in particular six, outer strands that surround the central strand (in a ring shape). Additionally or alternatively, a ratio of a diameter of a thinnest of the strands to a diameter of a thickest of the strands may be at least 0.8, in particular at least 0.9.

The outer strands can surround the central strand in one or more layers. In this case, for example, each layer can comprise at least six outer strands. Different layers can contain the same or different numbers of outer strands. A distance between adjacent outer strands (of the same layer) can, for example, be a maximum of 0.5 mm, in particular a maximum of 0.1 mm. For example, the diameter of the central strand and/or each outer strand can be between 1 mm and 3 mm. The central strand can be thicker than any outer strand. But the opposite is also possible.

This means that the tension members can be made particularly thin, i.e., particularly weight-saving, without significantly affecting the load-bearing capacity of the belt. By means of this embodiment, a linear weight of less than 500 g/m, in particular less than 250 g/m, can be achieved.

Belts with a ratio of breaking load (in kN) to weight per meter (g/m) of greater than 0.2, in particular greater than 0.3, preferably greater than 0.4, particularly preferably greater than 0.5 kN*m/g have proven to be advantageous.

This provides a comparatively light belt with a comparatively high breaking load.

According to one embodiment, the tension members may comprise at least one (cord-shape) first tension member and at least one (cord-shape) second tension member, which differ from one another in their lay direction. A lay direction can be understood as an S- or Z-lay, for example.

According to one embodiment, the tension members may comprise multiple first tension members and multiple second tension members, which are arranged distributed over a width of the belt body. At least one of the second tension members can be arranged between adjacent first tension members. In other words, the first and second tension members can be arranged alternately across the width of the belt body. This can reduce the likelihood of the belt twisting under load. This effect can be enhanced by embedding the same number of first and second tension members in the belt body, i.e., by choosing an even number of tension members. For example, if there are four tension members in total, two first tension members and two second tension members can be embedded in the tension member; if there are six tension members in total, three first tension members and three second tension members, etc.

According to one embodiment, at least four tension members can be embedded in the belt body. Additionally or alternatively, the number of tension members embedded in the belt body can be even. This can further improve the running behavior of the belt under load.

According to one embodiment, a film made of an electrically conductive material, in particular copper, can be applied to the back side. For example, the film can extend over the entire length of the belt. This simplifies monitoring the belt. In particular, this enables monitoring by measuring the resistance of the film (a significant change in the measured electrical resistance indicates damage to the belt).

According to one embodiment, at least one steel tension member can additionally be embedded in the belt body. The steel tension member can be designed as a cable or strand. For example, the steel tension member can be formed by multiple steel strands twisted together, wherein each steel strand can be formed by multiple steel wires twisted together. Alternatively, the steel tension member can be formed by a single steel strand (e.g., for weight reasons). This design allows easier monitoring of the belt compared to a design without steel tension members. In particular, this enables monitoring of the belt by means of a resistance measurement on the steel tension member.

According to one embodiment, each tension member can have a fire-retardant sheathing, in particular a fire-retardant polyurethane sheathing. This reduces the risk of fire. The fire-retardant sheathing can, for example, be made of a plastic material comprising at least one of the following fire-retardant additives: melamine phosphate, melamine polyphosphate, melamine cyanurate, ammonium n polyphosphate, a halogenated organic compound, an organic phosphoric acid ester, organic phosphonate, red phosphorus, metal hydroxide, metal carbonate, glass powder, quartz powder.

The fire-retardant sheathing may be formed at least partially by the belt body. In other words, the fire-retardant sheathing can be made of the same material as the belt body, or partially or completely of a different material than the belt body.

According to one embodiment, a traction side of the belt is without fire-retardant material, while a back side facing away from the traction side is made with the fire-retardant material.

According to one embodiment, the groove profile can be formed by multiple elevations and depressions, the respective longitudinal directions of which can run parallel to the longitudinal direction of the belt. In this case, each tension member can be embedded in one of the elevations in such a manner that a cross-sectional area of the elevation covers at least half the cross-sectional area of the tension member. This allows the belt to be made particularly flat. Among other things, this improves the flexibility of the belt.

According to one embodiment, a diameter of each tension member may correspond to at least 70% of a total height of the belt. Such a ratio has proven in tests to be particularly favorable with regard to the weight and service life of the belt.

According to one embodiment, the molding of the belt body may comprise the following steps: molding a base body by embedding the preheated tension members in the elastomer material, by extruding the elastomer material in a first extrusion step; molding the belt body by applying the traction side and the back side to the base body, by again extruding the elastomer material in at least one second extrusion step.

It is possible that the traction side and the back side are applied to the base body in separate extrusion steps. For example, in this case the back side can be applied before the traction side (but the opposite is also possible).

Alternatively, the traction side and the back side can be applied to the base body simultaneously, i.e., in a common extrusion step. This can further improve the efficiency of the method.

The same elastomer material can be extruded in different extrusion steps. Alternatively, different compositions of the elastomer material can be extruded in different extrusion steps. In this way, for example, the respective properties of the base body, the traction side and/or the back side can be specifically adjusted (independently of each other).

In some cases it may be useful to vulcanize the elastomer material instead of extruding it. This is especially the case when using ethylene propylene diene rubber elastomers (EPDM).

According to one embodiment, the elevator system may further comprise a traction sheave, wherein the belt can contact the traction sheave with its traction side. In this case, a diameter of the traction sheave can be larger than a diameter of a thickest strand of the belt by a factor of 80 to 120, in particular 90 to 110. Such size ratios have proven to be particularly suitable for practical use in experiments.

Additionally or alternatively, the elevator car may comprise its own brake, which is designed to slow down and/or hold the elevator car during normal operation of the elevator system. This elevator car brake can, for example, be a mechanical brake mounted on the elevator car. The elevator car brake can be provided in addition to a safety brake (which only intervenes in an emergency). This improves driving comfort. In particular, this can prevent vibrations in the elevator car during braking, which could impair ride comfort. Such vibrations can occur more frequently when using aramid tension members than when using steel tension members, and can lead to undesirable losses in driving comfort, particularly at high lifting heights (long belts).

Additionally or alternatively, the elevator system may comprise a further traction sheave, wherein the belt contacts the further traction sheave with its traction side.

It is advantageous that when using two traction sheaves (i.e., two drives), each of the drives can be built comparatively small and light. This creates an elevator system that can be easily installed due to the low weight of the drives and the belt.

According to one embodiment, the elevator system is designed with a lifting height of greater than 100 m, preferably greater than 150 mm, in particular greater than 200 m, particularly preferably greater than 250 m, advantageously greater than 300 m.

The advantages (energy savings during operation, easy installation) of using comparatively light belts (and drives) are particularly pronounced at high lifting heights.

In such elevator systems, the compensation medium, if present, is also lighter. This facilitates the installation of the elevator system and enables energy-efficient operation of the elevator system.

Advantageous embodiments of the invention are described in more detail below with reference to the accompanying drawings, wherein neither the drawings nor the description are intended to be interpreted as limiting the invention in any way.

### DESCRIPTION OF THE DRAWINGS

FIG. 1 shows an elevator system according to one embodiment of the invention.

FIG. 2 shows a cross-sectional view of a belt according to one embodiment of the invention.

FIG. 3 shows a cross-sectional view of a tension member of the belt.

The drawings are merely schematic and are not to scale. The same reference symbols in different drawings indicate the same or equivalent features.

### DETAILED DESCRIPTION

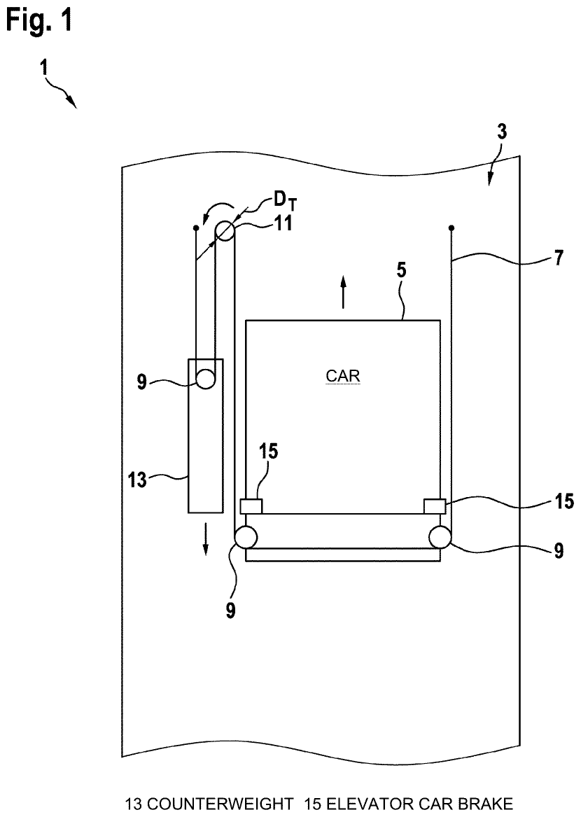

FIG. 1 shows an elevator system 1 for transporting persons and/or objects between floors of a multi-story building. The elevator system 1 comprises an elevator shaft 3 and an elevator car 5, which is arranged in the elevator shaft 3 so that it can move between the floors. The elevator car 5 is suspended from a belt 7, which is guided over multiple deflection rollers 9 and a traction sheave 11 for driving the belt 7. In addition, the elevator car 5 is connected to a counterweight 13 via the belt 7. By rotating the traction sheave 11 and correspondingly displacing the belt 7 frictionally connected to the traction sheave 11, depending on the direction of rotation, either the elevator car 5 is raised and the counterweight 13 is lowered (as indicated by arrows in FIG. 1) or the elevator car 5 is lowered and the counterweight 13 is raised. The elevator system shown in FIG. 1 shows a 2:1 suspension. The invention described above and below can also be implemented with a 1:1 suspension (not shown).

The elevator car 5 can be equipped with its own, in particular mechanical, elevator car brake 15, which additionally brakes the elevator car 5 during normal operation of the elevator system 1, for example to stop at a destination floor.

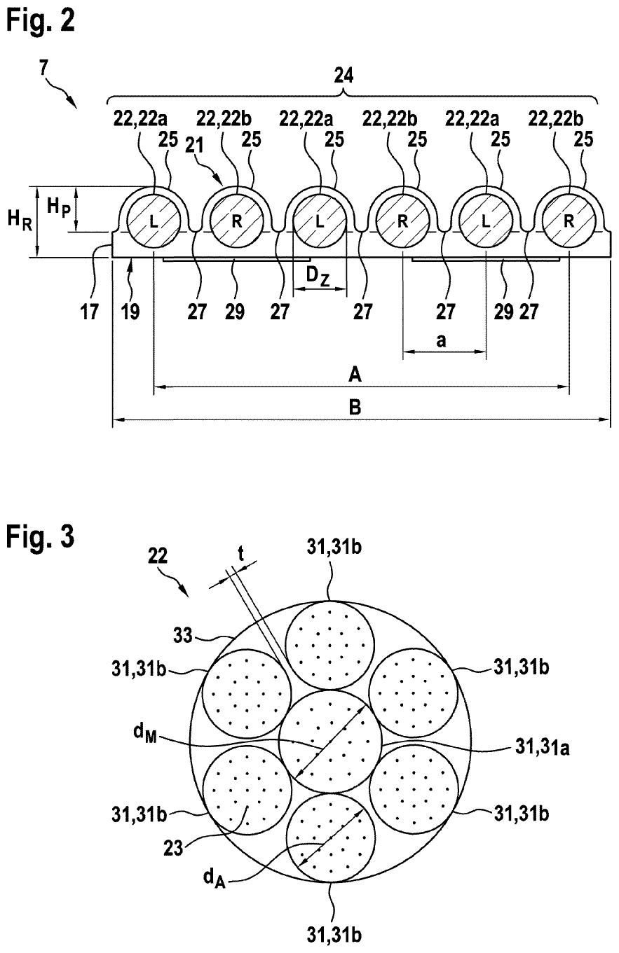

FIG. 2 and FIG. 3 show the detailed structure of the belt 7.

As can be seen in FIG. 2, the belt 7 comprises a belt body 17 with a back side 19 and a traction side 21—with which the belt 7 contacts the traction sheave 11—opposite the back side 19. The belt body 17 can be made of an elastomer material, in particular polyurethane, for example by extrusion (see below).

Embedded in the belt body 17 are multiple tension members 22 which absorb the majority of the tensile forces acting on the belt 7 during operation of the elevator system 1. The tension members 22 are each made entirely of aramid fibers 23 (see FIG. 3).

In this example, the belt body 17 is flat on the back side 19. However, it is also possible that the belt body 17 is specially structured on the back side 19.

On the traction side 21, the belt body 17 has a groove profile 24 adapted to an outer contour of the traction sheave 11, which in this example is formed from multiple elongated elevations 25 and depressions 27 which are arranged alternately over a width B of the belt body 17. The respective longitudinal directions of the elevations 25 and depressions 27 can run parallel to the longitudinal direction of the belt body 17 (i.e., the belt 7).

Each tension member 22 can run partially or completely within one of the elevations 25. For example, a cross-sectional area of each elevation 25 can comprise 60% to 90% of a cross-sectional area of the tension member 22 extending therein (the cross-sectional area of the elevation 25 is delimited from the rest of the belt body 17 in FIG. 2 by a dashed horizontal line). This allows the belt 7 to be made particularly flat.

For stability reasons, each tension member 22 should be embedded so deeply into the belt body 17 that a belt body material surrounding the tension member 22 is at least 1 mm thick at its thinnest point.

An electrically conductive film 29 for monitoring the belt 7 (in particular by measuring an electrical resistance on the film 29) can optionally be applied to the (flat) back side 19. It is expedient if the film 29 extends over the entire length of the belt body 17 (or a length section of the belt body 17 relevant for monitoring). The film 29 can be applied to the back side 19 in the form of a single web or—as can be seen in FIG. 2—in the form of two or more parallel webs.

In particular, a profile height H_{P} of the groove profile 24 can be equal to half the total height H_{R} of the belt 7 or greater than half the total height H_{R}. In this example, the profile height H_{P} corresponds to a vertical distance (i.e., orthogonal to the width B) between a highest point of the elevations 25 and a lowest point of the depressions 27, and the total height H_{R} corresponds to a vertical distance (i.e., orthogonal to the width B) of the back side 19 to the traction side 21, more precisely to the highest point of the elevations 25.

The tension members 22 can be evenly distributed over the width B (in addition, the tension members 22 can be arranged in multiple layers one above the other).

The total height H_{R} can, for example, be between 6.0 mm and 12.0 mm (plus/minus 0.1 mm), in particular between 7.4 mm and 10.5 mm (plus/minus 0.1 mm).

The profile height H_{P} can, for example, be between 4.5 mm and 8.5 mm (plus/minus 0.1 mm), in particular between 4.8 mm and 7.9 mm (plus/minus 0.1 mm).

The width B can, for example, be between 30.0 mm and 60.0 mm (plus/minus 0.5 mm), in particular between 33.0 mm and 48.0 mm (plus/minus 0.5 mm).

A diameter D_{Z} of the tension members 22 can, for example, be between 4.00 mm and 9.00 mm (plus/minus 0.02 mm), in particular between 5.40 mm and 7.70 mm (plus/minus 0.02 mm). The diameter D_{Z} can correspond to at least 70% of the total height H_{R}.

A distance a (in the direction of the width B) between adjacent tension members 22 can, for example, be between 7.0 mm and 14.0 mm (plus/minus 0.1 mm), in particular between 8.4 mm and 12.0 mm (plus/minus 0.1 mm).

A distance A (in the direction of the width B) between the two outermost tension members 22 can, for example, be between 20.0 mm and 45.0 mm (plus/minus 0.2 mm), in particular between 25.2 mm and 36.0 mm (plus/minus 0.2 mm).

The tension members 22 can be cord-shape and comprise first tension members 22ₐ with lay direction S (indicated in FIG. 2 with L for «left-handed rope>) and second tension members 22_{b} with lay direction Z (indicated in FIG. 2 with R for «right-handed rope»).

The first tension members 22a and the second tension members 22b can be arranged alternately in the direction of the width B. This can counteract the tendency of the belt 7 to twist under load.

In addition, the same number of first tension members 22a as second tension members 22b can be embedded in the belt body 17, here three each, i.e., a total of six tension members 22. The even number of tension members 22 can further improve the running behavior of the belt 7 under load.

In addition, at least one steel tension member (not shown) may be embedded in the belt body 17. The steel tension member can be used to monitor the belt 7 (in addition to or alternatively to the above-mentioned film 29).

As can be seen in FIG. 3, each tension member 22 can be formed from multiple strands 31 which can be twisted together in the lay direction S or Z.

The strands 31 can in turn be formed from multiple aramid fibers 23 twisted together.

For example, the strands 31 can comprise a thicker central strand 31a and multiple (here six) thinner outer strands 31b, wherein the outer strands 31b can be arranged distributed around the central strand 31a at uniform tangential intervals (i.e., uniformly in the circumferential direction of the central strand 31a).

A diameter d_{M} of the central strand 31a can, for example, be between 1.50 mm and 3.50 mm (plus/minus 0.01 mm), in particular between 2.05 mm and 2.90 mm (plus/minus 0.01 mm).

A diameter d_{A} of the outer strands 31b can, for example, be between 1.50 mm and 3.50 mm (plus/minus 0.01 mm), in particular between 1.85 mm and 2.65 mm (plus/minus 0.01 mm).

For example, a diameter D_{T} of the traction sheave 11 can be larger than the diameter d_{M} by a factor of 80 to 120, in particular 90 to 110.

A tangential distance t between adjacent outer strands 31b can, for example, be between 0.00 mm and 0.30 mm (plus/minus 0.01 mm), in particular between 0.10 mm and 0.15 mm (plus/minus 0.01 mm).

In addition to the embodiment of a 1+6 tension member shown in FIG. 3, tension members with a 1+5, 1+7 or a Warrington construction can be used in further embodiments (not shown).

In order to reduce the risk of fire, each tension member 22 can additionally be covered with a special fire-retardant sheathing 33. The sheathing 33 may be made of the same material as the belt body 17 or a different material than the belt body 17. In particular, the material of the sheath 33 may comprise polyurethane and additionally at least one fire-retardant additive.

The belt 7 can be manufactured very efficiently by extrusion. A corresponding manufacturing process can, for example, comprise the following steps.

In a first step, the (finished) tension members 22 are provided. The tension members 22 can be positioned relative to one another in the way in which they are later to be located in the belt body 17.

In a second step, the tension members 22 are locally heated, at least in those sections which are to be embedded in the elastomer material by extrusion of an elastomer material, until a temperature between 120° C. and 160° C., preferably between 130° C. and 150° C., particularly preferably between 135° C. and 145° C., is measured there.

In a third step, the belt body 17 is formed (and thus the belt 7 is manufactured). For this purpose, the elastomer material is extruded. The preheated sections of the tension members 22 are surrounded with the extruded elastomer material.

The third step can, for example, comprise multiple sequential extrusion steps. In a first extrusion step, a base body can be formed into which the tension members 22 are embedded. In a second extrusion step, the back side can be applied to the base body. Finally, in a third extrusion step, the traction side can be applied to the base body. The product of the third extrusion step then represents the (finished) belt 7.

However, the belt body 17 can also be formed in a single extrusion step.

Alternatively, the belt body 17 can be molded from the elastomer material. Finally, it should be noted that terms such as, for example, “having” or “comprising” do not exclude other elements or steps, and indefinite articles such as “a” or “an” do not exclude a plurality. Furthermore, it should be noted that features or steps described with reference to one of the above embodiments can also be used in combination with features or steps described with reference to other of the above embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A belt for carrying an elevator car and/or a counterweight of an elevator system, the belt comprising:
a belt body having a traction side adapted to contact a traction sheave of the elevator system and a back side opposite the traction side, wherein the belt body has on the traction side a groove profile adapted to an outer contour of the traction sheave and a profile on the back side deviating from the groove profile; and
a plurality of tension members embedded in the belt body for transmitting tensile forces, wherein each of the tension members is formed by multiple strands twisted together, and each of the strands is formed by multiple metallic or non-metallic fibers twisted together.

18. The belt according to claim 17 wherein a profile height of the groove profile corresponds to at least half of a total height of the belt.

19. The belt according to claim 17 wherein the belt body is flat on the back side.

20. The belt according to claim 17 wherein the strands of each of the tension members include a central strand surrounded by multiple outer strands.

21. The belt according to claim 17 wherein a ratio of a diameter of a thinnest of the strands to a diameter of a thickest of the strands is at least 0.8.

22. The belt according to claim 17 wherein a ratio of a breaking load of the belt to a width of the belt is between 5.2 kN/mm and 5.4 kN/mm.

23. The belt according to claim 17 wherein the tension members include at least one first tension member and at least one second tension member that differ in a direction of lay.

24. The belt according to claim 23 wherein a plurality of the at least one first tension member and a plurality of the at least one second tension member are arranged distributed over a width of the belt body, wherein at least one of the second tension members is arranged between two adjacent ones of the first tension members.

25. The belt according to claim 17 wherein at least four of the tension members are embedded in the belt body.

26. The belt according to claim 17 wherein an even number of the tension members is embedded in the belt body.

27. The belt according to claim 17 wherein the back side has a film made of an electrically conductive material applied thereto.

28. The belt according to claim 27 wherein the electrically conductive material is copper.

29. The belt according to claim 17 wherein the tension members include at least one steel tension member.

30. The belt according to claim 17 wherein each of the tension members has a fire-retardant sheathing.

31. The belt according to claim 17 wherein the groove profile is formed as multiple elevations and depressions and wherein each of the tension members is embedded in an associated one of the elevations such that a cross-sectional area of each the elevations is at least half of a cross-sectional area of the associated tension member.

32. The belt according to claim 17 wherein a diameter of each of the tension members corresponds to at least 70% of a total height of the belt.

33. A method for producing a belt for carrying an elevator car and/or a counterweight of an elevator system, the method comprising steps of:
providing a plurality of tension members adapted to transmit tensile forces, each of the tension members being formed by multiple strands twisted together, and each of the strands being formed by multiple aramid fibers twisted together;
preheating the tension members to a temperature between 120° C. and 160° C.; and
molding a belt body embedding the tension members therein, the belt body having a traction side adapted to contact a traction sheave of the elevator system and a back side opposite the traction side, the molding forming the belt body by extruding an elastomer material embedding the preheated tension members.

34. The method according to claim 33 wherein the molding the belt body includes:
molding a base body by embedding the preheated tension members in the elastomer material being extruded in a first extrusion step; and
molding the belt body by applying the traction side and the back side to the base body by again extruding the elastomer material in at least a second extrusion step.

35. An elevator system comprising:
a belt including a belt body and a plurality of tension members;
wherein the belt body has a traction side adapted to contact a traction sheave of the elevator system and a back side opposite the traction side, wherein the belt body has on the traction side a groove profile adapted to an outer contour of the traction sheave and a profile on the back side deviating from the groove profile;
the tension members being embedded in the belt body for transmitting tensile forces, wherein each of the tension members is formed by multiple strands twisted together, and each of the strands is formed by multiple metallic or non-metallic fibers twisted together;
an elevator shaft;
an elevator car movable in the elevator shaft, the belt carrying the elevator car; and/or
a counterweight movable in the elevator shaft, the belt carrying the counterweight.

36. The elevator system according to claim 35 wherein the traction sheave has a diameter that is greater by a factor of 80 to 120 than a diameter of a thickest one of the strands of the belt.
